(19) United States
(12) Patent Application Publication
(10) Pub. No.: US 2010/0287270 A1
(43) Pub. Date: Nov. 11, 2010

(54) CONTROL PROXY APPARATUS AND CONTROL PROXY METHOD

(75) Inventors: Hiroshi Hashimoto, Osaka (JP); Mitsuhiro Sato, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/778,483

(22) Filed: May 12, 2010

Related U.S. Application Data
(63) Continuation of application No. PCT/JP2007/072031, filed on Nov. 13, 2007.

(51) Int. Cl. G06F 13/00

(52) U.S. Cl. 709/223

(57) ABSTRACT

A control proxy apparatus includes: a management-apparatus-information storage unit that stores identification information for uniquely identifying a management apparatus that manages various apparatuses and a communication format of the management apparatus; an apparatus-information storage unit that stores apparatus information for executing various types of control, in association with each control target apparatus; an authenticating unit that determines, when receiving a control request from the management apparatus, whether authentication information in the control request is stored in the management-apparatus-information storage unit; an apparatus-information acquiring unit that acquires, when the authenticating unit determines that the authentication information is stored in the management-apparatus-information storage unit, apparatus information corresponding to the control target apparatus, from the apparatus-information storage unit; and a control executing unit that converts control information in the control request based on the apparatus information acquired by the apparatus-information acquiring unit, and executes the converted control information on the control target apparatus.

### CROSS-REFERENCE TO RELATED APPLICATION(S)

This application is a continuation of International Application No. PCT/JP2007/072031, filed on Nov. 13, 2007, the entire contents of which are incorporated herein by reference.

### FIELD

The embodiments discussed herein are directed to a control proxy apparatus, a control proxy method, and a control proxy program for receiving a control request for requesting execution of various types of control from a plurality of management apparatuses that manage various apparatuses, and executing the various types of control on an apparatus to be a control target apparatus.

### BACKGROUND

In recent years, NETCONF promoted as a standard by the Netconf WG of the IETF (The Internet Engineering Task Force) has attracted attention as a means for performing advanced control such as configuration information setting and security setting on network equipments.

However, in order to make the network equipments compatible with a NETCONF protocol and the like, it is necessary to implement a protocol stack such as HTTP (Hypertext Transfer Protocol), HTTPS (Hypertext Transfer Protocol Security), SOAP (Simple Object Access Protocol), and NETCONF in the network equipments to be controlled. Therefore, various technologies have been proposed for performing advanced control similar to NETCONF even on control target apparatuses that are not compatible with the NETCONF protocol and the like.

For example, Japanese Laid-open Patent Publication No. 2006-338417 discloses a technology for allowing an SNMP management apparatus to control a non-SNMP equipment by providing a proxy server. More specifically, the proxy server receives a control instruction using SNMP from the SNMP management apparatus, converts the received control instruction into a unique protocol, and issues a control comment to a control target apparatus. The proxy server also converts a control result that is received from the control target apparatus and is compliant with the unique protocol into SNMP, and notifies the SNMP management apparatus of the control result.

However, the above-mentioned conventional technology has problems in that the technology is dependent on a communication format of a management apparatus that transmits a control instruction to a control target apparatus, it is impossible to authenticate the validity of the management apparatus, and it is impossible to perform advanced control such as configuration information setting and security setting. More specifically, because the management apparatus that transmits a control instruction to a control target apparatus depends on SNMP, any apparatuses that are unable to use SNMP cannot be used as the management apparatus. Therefore, usability of a whole system is degraded, leading to lack of versatility. Furthermore, because any apparatuses that use SNMP can be the management apparatus, it is impossible to detect unauthorized management apparatuses.

Moreover, because the proxy server receives a control instruction using SNMP with which advanced control cannot be performed (with which advanced control instructions cannot be specified) from the SNMP management apparatus, it is impossible to perform advanced control on a control target apparatus. For example, when a control target apparatus is a network equipment such as a router, because control instructions such as change, addition, and deletion of security settings of firewalls and VPNs (Virtual Private Networks) cannot be specified with SNMP, the proxy server cannot control such security settings on the control target apparatus.

### SUMMARY

According to an aspect of an embodiment of the invention, a control proxy apparatus includes: a management-apparatus-information storage unit that stores therein identification information for uniquely identifying each of a plurality of management apparatuses that manage various apparatuses and a communication format of each of the management apparatuses; an apparatus-information storage unit that stores therein apparatus information for executing various types of control, in association with each apparatus to be a control target apparatus; an authenticating unit that determines, when receiving a control request for requesting execution of various types of control from the plurality of management apparatuses, whether authentication information stored in the control request is stored in the management-apparatus-information storage unit; an apparatus-information acquiring unit that acquires, when the authenticating unit determines that the authentication information is stored in the management-apparatus-information storage unit, apparatus information corresponding to the control target apparatus to be controlled by the received control request, from the apparatus-information storage unit; and a control executing unit that converts control information contained in the control request and indicating control contents based on the apparatus information acquired by the apparatus-information acquiring unit, and executes the converted control information on the control target apparatus.

According to another aspect of an embodiment of the invention, a control proxy method includes: firstly storing identification information for uniquely identifying each of a plurality of management apparatuses that manage various apparatuses and a communication format of each of the management apparatuses; secondly storing apparatus information for executing various types of control, in association with each apparatus to be a control target apparatus; determining, when receiving a control request for requesting execution of various types of control from the plurality of management apparatuses, whether authentication information stored in the control request is stored in the firstly storing; acquiring, when it is determined in the determining that the authentication information is stored in the firstly storing, apparatus information corresponding to the control target apparatus to be controlled by the received control request, from information stored in the secondly storing; and converting control information contained in the control request and indicating control contents based on the apparatus information acquired in the acquiring, and executing the converted control information on the control target apparatus.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a system configuration diagram illustrating an entire configuration of a system including a network protocol proxy server according to a first embodiment;

FIG. 2 is a block diagram illustrating a configuration of the network protocol proxy server according to the first embodiment;

FIG. 3 illustrates an example of information stored in a management apparatus information DB;

FIG. 4 illustrates an example of information stored in an apparatus individual information DB;

FIG. 5 illustrates an example of information stored in an address information DB;

FIG. 6 is a flowchart illustrating a flow of a control execution process in the network protocol proxy server according to the first embodiment;

FIG. 7 is a flowchart illustrating a flow of a control-execution-result return process in the network protocol proxy server according to the first embodiment;

FIG. 8 is a sequence diagram illustrating a flow of a control-execution/result-return process in the network protocol proxy server according to the first embodiment;

FIG. 9 is a flowchart illustrating a flow of an additional registration process for additionally registering a new management apparatus according to a second embodiment;

FIG. 10 is a sequence diagram illustrating a flow of an additional registration process for additionally registering a new control target apparatus according to a third embodiment;

FIG. 11 is a sequence diagram illustrating a flow of an apparatus-individual-information DB update process according to a fourth embodiment; and

FIG. 12 is a diagram illustrating an example of a computer that executes a control proxy program.

### DESCRIPTION OF EMBODIMENT(S)

Preferred embodiments of the present invention will be explained with reference to the accompanying drawings. In the following, main terms used in the embodiment, the outline and the characteristics of a control proxy apparatus according to the embodiment, and the configuration and process flows of the control proxy apparatus will be described in this order, and thereafter various modified examples of the embodiment will be explained.

### [a] First Embodiment

Definition of Terms

First, main terms used in the embodiment are described. In the embodiment, “management apparatus A” and “management apparatus B” are computer terminals that implement a network management system (NMS) and the like that performs advanced control such as configuration information setting and security setting on control target apparatuses. “Control target apparatus A” and “control target apparatus B” are network equipments, such as routers, switches, and firewalls, or computer terminals, such as WEB servers that receive various control instructions from a “network protocol proxy server”, execute the control instructions, and return a result to the “network protocol proxy server”.

The “network protocol proxy server (which may also referred to as “control proxy apparatus”)” is a network equipment that receives control instructions from the management apparatus A and the management apparatus B, transmits the control instructions to a control target apparatus in place of the management apparatus A and the management apparatus B, and returns a control result to the management apparatuses. The “network protocol proxy server” is compatible with various network protocols such as NETCONF, SNMP, and various CLIs (Command Line Interface) for controlling control target apparatuses. In the embodiment, a system including two management apparatuses A and B, a network protocol proxy server, and two control target apparatuses A and B is explained as an example. However, the number of the management apparatuses, the network protocol proxy servers, and the control target apparatuses is not limited to this example.

Outline and Characteristics of the Network Protocol Proxy Server

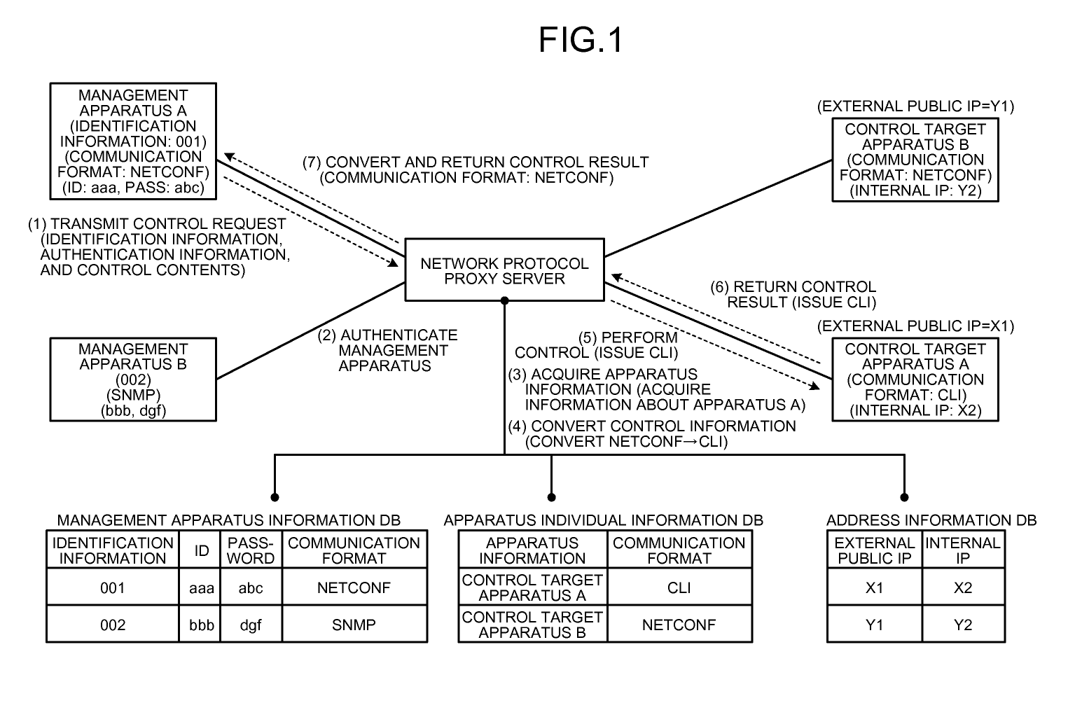

Next, the outline and the characteristics of the network protocol proxy server according to the first embodiment are explained with reference to FIG. 1. FIG. 1 is a system configuration diagram illustrating an overall configuration of a system including the network protocol proxy server according to the first embodiment.

As illustrated in FIG. 1, the system includes the management apparatus A and the management apparatus B that perform advanced control such as configuration information setting and security setting, the network protocol proxy server that transmits control instructions in place of each management apparatus, and the control target apparatus A (IP address=X1) and the control target apparatus B (IP address =Y1) to be subjected to various types of control.

The management apparatus A stores therein “001” as “identification information” for identification, and “aaa, abc” as an “ID” and a “password” set by an administrator of the management apparatus A. Similarly, the management apparatus B stores therein “002” as the “identification information”, and “bbb, dgf” as the “ID” and the “password”. The management apparatus A uses “NETCONF” as a protocol (communication format) when performing communication with other apparatuses. Similarly, the management apparatus B uses “SNMP” as a protocol (communication format) when performing communication with other apparatuses.

With this configuration, as described above, the network protocol proxy server is summarized in that it receives a control request for requesting execution of various types of control from a plurality of management apparatuses (the management apparatus A and the management apparatus B) that manage various apparatuses, and executes the various types of control on apparatuses to be control target apparatuses (the control target apparatus A and the control target apparatus B). In particular, the network protocol proxy server is mainly characterized in the point that it can authenticate the validity of the management apparatuses and perform advanced control independent of the communication formats employed by the management apparatuses.

To specifically explain the main characteristics, the network protocol proxy server stores identification information for uniquely identifying each of management apparatuses and a communication format of each of the management apparatuses in a management apparatus information DB. For example, the management apparatus information DB of the network protocol proxy server stores therein “001, aaa, abc, NETCONF”, “002, bbb, dgf, SNMP”, and the like as ““identification information” for uniquely identifying a management apparatus, an “ID” uniquely assigned to an administrator of the management apparatus, a “password” for identifying the administrator of the management apparatus, and a “communication format” indicating a protocol used for communication with the management apparatus”. In other words, because “identification information=001, communication format=NETCONF”, and the like are stored in the management apparatus information DB, the network protocol proxy server performs communication using a “NETCONF” protocol with the management apparatus A storing “identification information=001”, and performs communication using an “SNMP” protocol with the management apparatus B storing “identification information=002”.

The network protocol proxy server also stores apparatus information necessary for executing various types of control in an apparatus individual information DB, in association with each apparatus to be a control target apparatus. More specifically, in the above-mentioned example, the apparatus individual information DB of the network protocol proxy server stores therein “control target apparatus A, CLI”, “control target apparatus B, NETCONF”, and the like as ““apparatus information” for uniquely identifying a control target apparatus, and a “communication format” indicating a protocol used for communication with the control target apparatus”.

The network protocol proxy server also stores address information containing an external IP address and an internal IP address associated with each other in an address information DB, in association with each apparatus to be a control target apparatus. More specifically, in the above-mentioned example, the address information DB of the network protocol proxy server stores therein “X1, X2”, “Y1, Y2”, and the like as “an “external public IP” indicating a global address for performing external communication with the Internet and the like, and an “internal IP” indicating a private address for performing internal communication with the intranet and the like”.

In this state, when receiving a control request from the plurality of management apparatuses, the network protocol proxy server determines whether authentication information contained in the control request is stored in the management apparatus information DB (see (1) and (2) of FIG. 1). More specifically, in the above-mentioned example, when receiving a control request containing “identification information=001, ID=aaa, password=abc, control instruction=VPN setting (NETCONF format), control target apparatus=control target apparatus A, a target-apparatus IP address=X1” from the management apparatus A, the network protocol proxy server determines whether the authentication information “ID=aaa, password=abc” contained in the control request is stored in the management apparatus information DB. In this example, because “ID=aaa, password=abc” is stored in the management apparatus information DB in association with “identification information=001”, the network protocol proxy server determines that the management apparatus A that has transmitted the control request is a valid apparatus.

When determining that the authentication information is stored in the management apparatus information DB, the network protocol proxy server acquires, from the apparatus individual information DB, apparatus information corresponding to a control target apparatus to be controlled by the received control request (see (3) of FIG. 1). More specifically, in the above-mentioned example, when determining that the authentication information “ID=aaa, password=abc” contained in the control request is stored in the management apparatus information DB, the network protocol proxy server acquires, from the apparatus individual information DB, apparatus information “apparatus information=control target apparatus A, communication format=CLI” corresponding to a control target apparatus “control target apparatus=control target apparatus A” to be controlled by the received control request.

Subsequently, the network protocol proxy server converts control information contained in the control request and indicating control contents based on the acquired apparatus information; acquires an internal IP address associated with an external IP address, which is contained in the control request and assigned to the control target apparatus, from the address information DB; and executes the converted control information on the control target apparatus by using the acquired internal IP address (see (4) and (5) of FIG. 1). More specifically, in the above-mentioned example, the network protocol proxy server converts the control information “control instruction=VPN setting (NETCONF format)” contained in the control request and indicating the control contents from the “NETCONF format” to the “CLI format” based on the acquired apparatus information “apparatus information=control target apparatus A, communication format=CLI”; acquires the internal IP address “internal IP=X2” associated with the external IP address “external public IP=X1” contained in the control request and assigned to the control target apparatus, from the address information DB; and executes the converted control information on the control target apparatus A by using the acquired internal IP address “internal IP=X2”.

Then, when receiving, from the control target apparatus, an execution result indicating a result of execution of the converted control information on the control target apparatus, the network protocol proxy server acquires, from the management apparatus information DB, a communication format corresponding to the management apparatus being a transmission destination of the control request, converts the control result based on the acquired communication format, and notifies the management apparatus of the converted control result (see (6) and (7) of FIG. 1). More specifically, in the above-mentioned example, the network protocol proxy server receives, from the control target apparatus A, an execution result in the “CLI format” indicating a result of execution of the converted control information on the control target apparatus A. Then, the network protocol proxy server converts the received execution result in the “CLI format” into a format compliant with the communication format “NETCONF” that corresponds to the management apparatus A being the transmission destination of the control request and that is stored in the management apparatus information DB; and notifies the management apparatus A of the converted execution result.

In this manner, the network protocol proxy server according to the first embodiment can perform advanced control even between the management apparatus and the control target apparatus that employ different communication formats, by converting the communication formats from one to the other. Therefore, as the above-described main characteristics, the network protocol proxy server is mainly characterized in the point that it can authenticate the validity of a management apparatus and perform advanced control independent of the communication format of the management apparatus.

Configuration of the Network Protocol Proxy Server

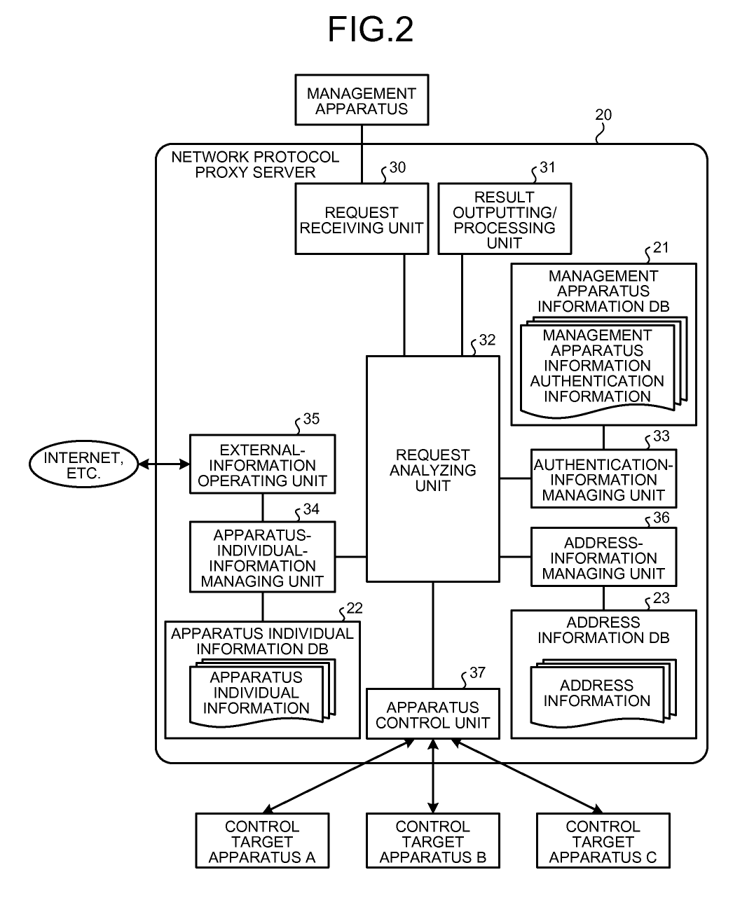

Next, the configuration of the network protocol proxy server illustrated in FIG. 1 is described with reference to FIG. 2. FIG. 2 is a block diagram illustrating the configuration of the network protocol proxy server according to the first embodiment. As illustrated in FIG. 2, a network protocol proxy server 20 includes a management apparatus information DB 21, an apparatus individual information DB 22, an address information DB 23, a request receiving unit 30, a result outputting/processing unit 31, a request analyzing unit 32, an authentication-information managing unit 33, an apparatus-individual-information managing unit 34, an external-information operating unit 35, an address-information managing unit 36, and an apparatus control unit 37.

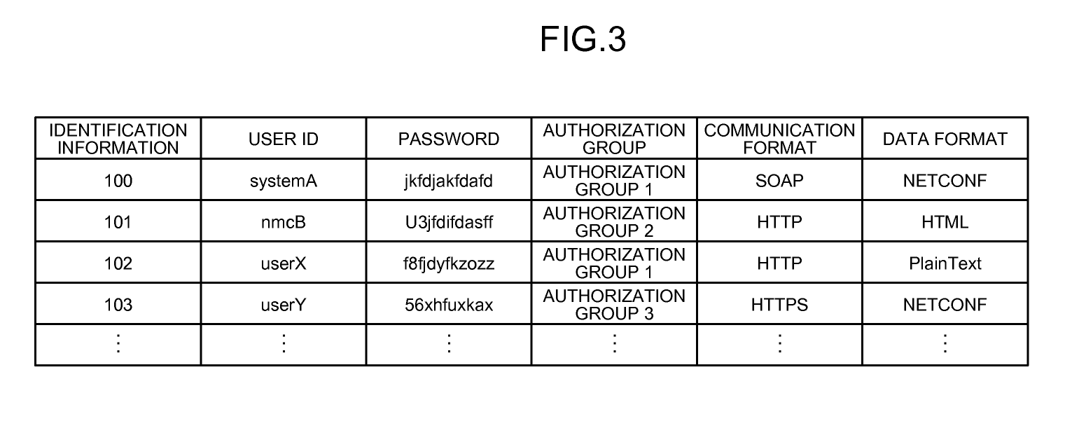

The management apparatus information DB 21 stores therein authentication information for uniquely identifying each of management apparatuses and a communication format of each of the management apparatuses. For example, as illustrated in FIG. 3, the management apparatus information DB 21 stores therein “100, systemA, jkfdjakfdafd, authorization group 1, SOAP, NETCONF”, “101, nmcB, U3jfdifdasff, authorization group 2, HTTP, HTML”, and the like as ““identification information” for uniquely identifying a management apparatus, a “user ID” uniquely assigned to an administrator of the management apparatus, a “password” for identifying the administrator of the management apparatus, an “authorization group” being a group assigned to the management apparatus depending on given authorization, a “communication format” indicating a protocol used for communication with the management apparatus, and a “data format” indicating a data format used for communication with the management apparatus. Here, FIG. 3 illustrates an example of information stored in the management apparatus information DB.

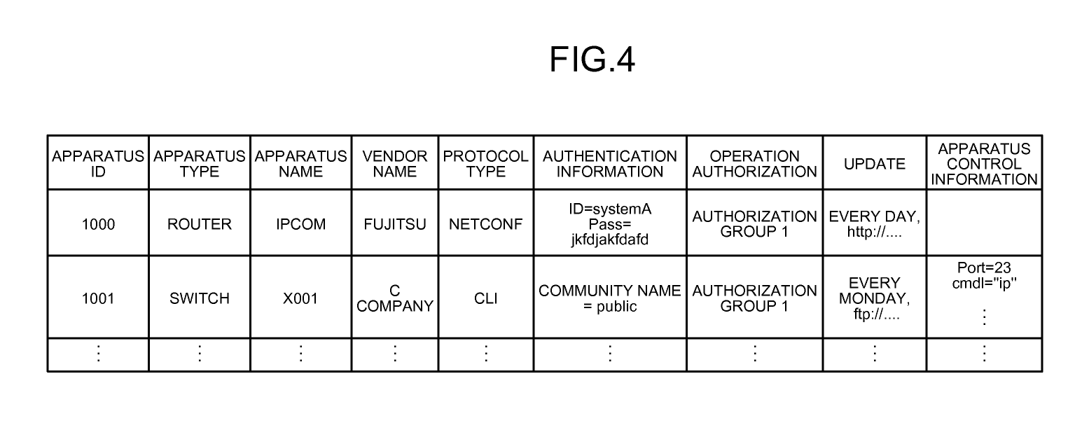

The apparatus individual information DB 22 stores therein apparatus information for executing various types of control, in association with each apparatus to be a control target apparatus. For example, as illustrated in FIG. 4, the apparatus individual information DB 22 stores therein “1000, router, IPCOM, FUJITSU, NETCONF, ID=systemA/PASS=jkfdjakfdafd, authorization group 1, every day, http:// . . . , −”, “1001, switch, X001, C company, CLI, community name=public, authorization group 1, every Monday, ftp:// . . . , Port=23/cmdl=“ip””, and the like as “an “apparatus ID” for uniquely identifying a control target apparatus, an “apparatus type” indicating a type of the apparatus, an “apparatus name” indicating a name of the apparatus, a “vendor name” indicating a manufacturing vendor of the apparatus, a “protocol type” indicating a communication format used by the apparatus, “authentication information” indicating information for authenticating the validity of the apparatus, “operation authorization” indicating authorization for operating the control target apparatus, “update information” indicating an interval for updating information of the apparatus and an acquisition source of the update information, and “apparatus control information” indicating various types of information for operating the apparatus”. Here, FIG. 4 illustrates an example of information stored in the apparatus individual information DB.

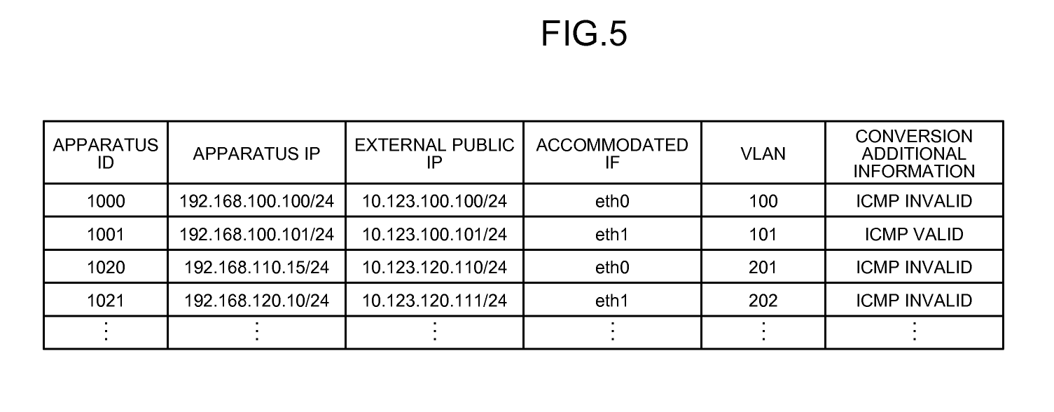

The address information DB 23 stores therein address information containing an external IP address and an internal IP address associated with each other, in association with each apparatus to be a control target apparatus. For example, as illustrated in FIG. 5, the address information DB 23 stores therein “1000, 192.168.100.100/24, 10.123.100.100/24, eth0, 100, ICMP invalid”, “1001, 192.168.100.101/24, 10.123.100.101/24, eth1, 101, ICMP valid”, and the like as “an “apparatus ID” for uniquely identifying a control target apparatus, an “apparatus IP” indicating a private address for performing internal communication with the intranet and the like, an “external public IP” indicating a global address for performing external communication with the Internet and the like, an “accommodated IF” indicating an interface to which the apparatus is connected, a “VLAN” indicating a VLAN assigned thereto, and “conversion additional information” indicating operational conditions for address conversion”. Here, FIG. 5 illustrates an example of information stored in the address information DB.

The request receiving unit 30 receives a control request for requesting execution of various types of control from a plurality of management apparatuses that manage various apparatuses. More specifically, the request receiving unit 30 receives a control request (protocol message) for NETCONF and the like from the connected management apparatus and a setting change request for the network protocol proxy server 20 itself from a maintenance operation terminal, and notifies the request analyzing unit 32 of the received connection request, setting change request, and the like.

The result outputting/processing unit 31 acquires, when receiving an execution result indicating a result of execution of the converted control information on the control target apparatus from the control target apparatus, a communication format corresponding to the management apparatus being a transmission destination of the control request from the management apparatus information DB 21, converts the control result based on the acquired communication format, and notifies the management apparatus of the converted control result.

A detailed example is described below assuming that a result of control executed on a control apparatus, which is corresponding to “apparatus ID=1000, apparatus type=router, apparatus name=IPCOM, vendor name=FUJITSU, protocol type=NETCONF, authentication information=ID=systemA/PASS=jkfdjakfdafd, operation authorization=authorization group 1, update information=every day, http:// . . . , apparatus control information=−” stored in the apparatus individual information DB 22, is returned to a management apparatus, which is corresponding to “identification information=101, user ID=nmcB, password=U3jfdifdasff, authorization group=authorization group 2, communication format=HTTP, data format=HTML” stored in the management apparatus information DB 21. In this case, because of “protocol type=NETCONF” of the control target apparatus, the result outputting/processing unit 31 receives a response result of “protocol type=NETCONF” from the control target apparatus via the request analyzing unit 32. Then, because of “communication format=HTTP, data format=HTML” of the management apparatus, the result outputting/processing unit 31 converts the received response result from “protocol type=NETCONF” to “communication format=HTTP, data format=HTML” being the communication format and the data format of the management apparatus, and transmits the converted response result to the management apparatus.

When the authentication-information managing unit 33 to be described later determines that the authentication information is stored in the management apparatus information DB 21, the request analyzing unit 32 acquires, from the apparatus individual information DB 22, apparatus information corresponding to the control target apparatus to be controlled by the received control request, converts the control information contained in the control request and indicating the control contents based on the acquired apparatus information, acquires an internal IP address associated with the external IP address contained in the control request and assigned to the control target apparatus from the address information DB 23, and executes the converted control information on the control target apparatus by using the acquired internal IP address.

More specifically, the request analyzing unit 32 performs the following operations as necessary based on the control contents and received IP address information input from the request receiving unit 30: authentication of a request source by notifying the authentication-information managing unit 33 of an authentication confirmation request; requesting of the apparatus-individual-information managing unit 34 to acquire apparatus-specific information of the control target apparatus, and acquisition of information for execution of IP address conversion by the address-information managing unit 36. Subsequently, the request analyzing unit 32 converts a protocol according to a result from each functional unit, and requests the apparatus control unit 37 to perform control input for inputting control information into the control target apparatus. The request analyzing unit 32 also receives a control input result from the apparatus control unit 37 and notifies the result outputting/processing unit 31 of the control input result to thereby return a result to a request source.

For example, when receiving a control request from a management apparatus having “identification information=101”, the request analyzing unit 32 outputs a request for authenticating the validity of the management apparatus to the authentication-information managing unit 33. When the authentication-information managing unit 33 determines that the authentication information is stored in the management apparatus information DB 21, the request analyzing unit 32 acquires, from the management apparatus information DB 21, apparatus information “identification information=101, user ID=nmcB, password=U3jfdifdasff, authorization group=authorization group 2, communication format=HTTP, data format=HTML” corresponding to the management apparatus being the transmission destination of the received control request. Subsequently, the request analyzing unit 32 outputs, to the apparatus-individual-information managing unit 34, a request for acquiring apparatus information of a control target apparatus corresponding to “identification information=1000” and to be controlled by the received control request. Then, the request analyzing unit 32 receives the apparatus information of the control target apparatus, i.e., “apparatus ID=1000, apparatus type=router, apparatus name=IPCOM, vendor name=FUJITSU, protocol type=NETCONF, authentication information=ID=systemA/PASS=jkfdjakfdafd, operation authorization=authorization group 1, update information=every day, http:// . . . , apparatus control information=−” from the apparatus-individual-information managing unit 34.

Then, the request analyzing unit 32 converts the control information contained in the control request and indicating the control contents from “communication format=HTTP, data format=HTML” of the management apparatus to “protocol type=NETCONF” of the control target apparatus, and requests the address-information managing unit 36 to perform conversion to an internal IP address associated with the external IP address contained in the control request and assigned to the control target apparatus. Then, the address-information managing unit 36 performs conversion to the internal IP address “192.168.100.100/24” associated with the external IP address “10.123.100.100/24” that is contained in the control request and assigned to the control target apparatus by referring to the address information DB 23. Then, the request analyzing unit 32 executes the converted control information of the “protocol type=NETCONF” on the control target apparatus by using the converted internal IP address. Subsequently, the request analyzing unit 32 outputs a control execution result to the result outputting/processing unit 31.

When receiving a control request from a plurality of management apparatuses, the authentication-information managing unit 33 determines whether authentication information contained in the control request is stored in the management apparatus information DB 21. More specifically, the authentication-information managing unit 33 receives an authentication request and the like from the request analyzing unit 32, and requests to refer to, register, update, and delete information in the management apparatus information DB 21. For example, when notified of reception of a control request containing “identification information=101, user ID=nmcB, password=U3jfdifdasff” by the request analyzing unit 32, the authentication-information managing unit 33 determines whether “identification information=101, user ID=nmcB, password=U3jfdifdasff” being the authentication information is stored in the management apparatus information DB 21. When the authentication information is stored in the management apparatus information DB 21, the authentication-information managing unit 33 notifies the request analyzing unit 32 of authentication success, and, when the authentication information is not stored in the management apparatus information DB 21, the authentication-information managing unit 33 notifies the request analyzing unit 32 of authentication failure. In this example, because “identification information=101, user ID=nmcB, password=U3jfdifdasff” is stored in the management apparatus information DB 21, the authentication-information managing unit 33 notifies the request analyzing unit 32 of authentication success.

The apparatus-individual-information managing unit 34 receives an apparatus-individual-information acquisition request and the like from the request analyzing unit 32, and requests to refer to, register, update, and delete information in the apparatus individual information DB 22. When appropriate apparatus information is not present in the apparatus individual information DB 22, the apparatus-individual-information managing unit 34 requests the external-information operating unit 35 to acquire information from external apparatuses. More specifically, when receiving the apparatus-individual-information acquisition request and the like from the request analyzing unit 32, the apparatus-individual-information managing unit 34 acquires, from the apparatus individual information DB 22, apparatus information corresponding to the “identification information” contained in the control request, and returns a response to the request analyzing unit 32. Furthermore, the apparatus-individual-information managing unit 34 refers to the “update information” of each apparatus information stored in the apparatus individual information DB 22, and requests the external-information operating unit 35 to acquire apparatus information based on the “update information”.

The external-information operating unit 35 periodically acquires update information of apparatus information for each control target apparatus from an external network, and updates the apparatus information stored in the apparatus individual information DB 22 with the acquired update information. More specifically, the external-information operating unit 35 receives an apparatus-information update request from the apparatus-individual-information managing unit 34, acquires information of an instructed apparatus from an external network such as the Internet, and the like by using HTTP and FTP, and returns a result to the apparatus-individual-information managing unit 34.

The address-information managing unit 36 converts the control information contained in the control request and indicating the control contents by referring to the address information DB 23 based on the apparatus information acquired by the request analyzing unit 32, and performs conversion to the internal IP address associated with the external IP address contained in the control request and assigned to the control target apparatus. More specifically, the address-information managing unit 36 receives an address-information acquisition request and the like from the request analyzing unit 32, and requests to refer to, register, update, and delete information in the address information DB 23. For example, when receiving the address-information acquisition request from the request analyzing unit 32, the address-information managing unit 36 acquires, from the address information DB 23, an “apparatus IP” stored in association with an “identification number” and an “external public IP”, which are contained in the control request received by the request receiving unit 30, and returns a response to the request analyzing unit 32.

The apparatus control unit 37 receives a control input request from the request analyzing unit 32, transmits control information in an instructed control format to the control target apparatus, receives a transmission result, and returns a response to the request analyzing unit 32. More specifically, the apparatus control unit 37 receives the control input request from the request analyzing unit 32, transmits control information in an instructed control format “NETCONF” to the control target apparatus, receives a transmission result, and returns a response to the request analyzing unit 32.

Process Performed by the Network Protocol Proxy Server

Flow of a control execution process

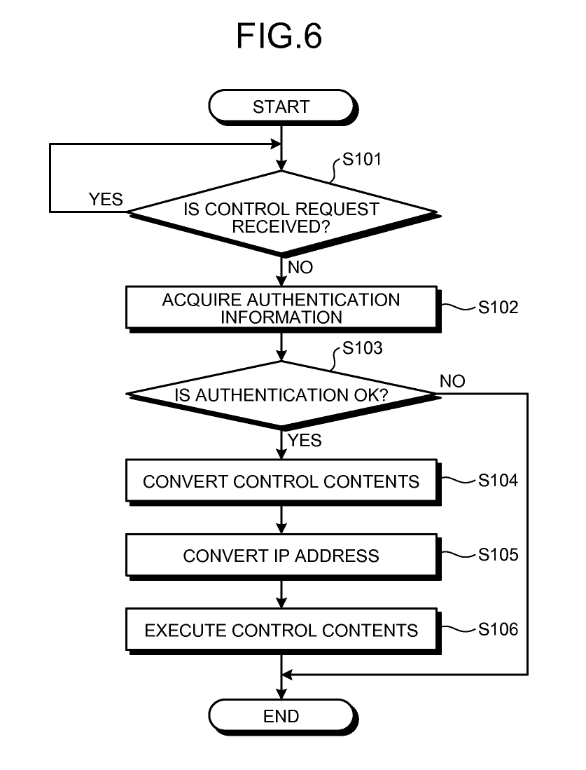

Next, a process performed by the network protocol proxy server is described with reference to FIG. 6. FIG. 6 is a flowchart illustrating a flow of the control execution process in the network protocol proxy server according to the first embodiment.

As illustrated in FIG. 6, when receiving a control request (YES at Step S101), the request analyzing unit 32 of the network protocol proxy server 20 sends authentication information contained in the control request to the authentication-information managing unit 33, and the authentication-information managing unit 33 performs authentication by using the received authentication information (Step S102).

When the authentication by the authentication-information managing unit 33 is successful (YES at Step S103), the request analyzing unit 32 of the network protocol proxy server 20 converts the control contents contained in the control request into a communication format corresponding to the control target apparatus based on the apparatus information that is acquired from the apparatus individual information DB 22 by the apparatus-individual-information managing unit 34 and corresponding to the control target apparatus to be controlled (Step S104). Here, the authentication-information managing unit 33 determines as “authentication OK” when the authentication information (e.g., an ID and a password, a community name, and the like) contained in the control request is stored in the management apparatus information DB 21.

Subsequently, the request analyzing unit 32 of the network protocol proxy server 20 converts an external public IP contained in the control request into an apparatus IP (internal IP) based on the address information that is acquired from the address information DB 23 by the address-information managing unit 36 and corresponding to the control target apparatus to be controlled (Step S105).

Then, the request analyzing unit 32 of the network protocol proxy server 20 outputs to the apparatus control unit 37 an instruction to execute the control contents, which has been converted into the communication format corresponding to the control target apparatus, on the apparatus IP converted from the external public IP. The apparatus control unit 37 then executes the control contents on the control target apparatus corresponding to the apparatus IP (Step S106).

Flow of a Control-Execution-Result Return Process

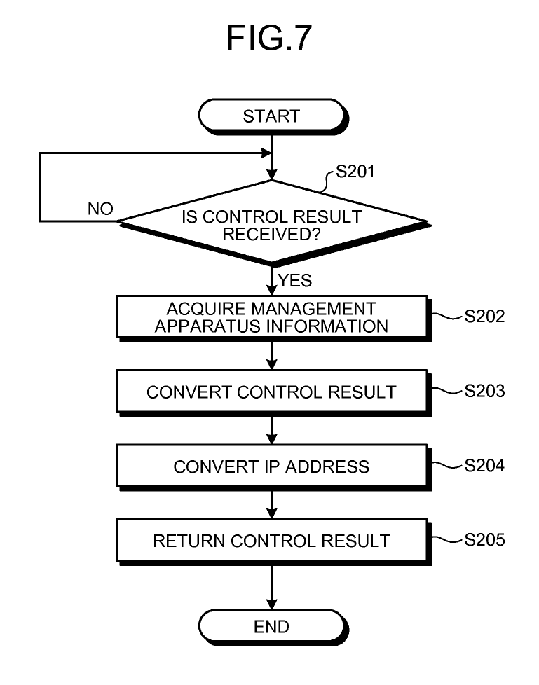

Next, a control-execution-result return process performed by the network protocol proxy server is described with reference to FIG. 7. FIG. 7 is a flowchart illustrating a flow of the control-execution-result return process in the network protocol proxy server according to the first embodiment.

As illustrated in FIG. 7, when receiving a result of control executed by the apparatus control unit 37 from the request analyzing unit 32 (YES at Step S201), the result outputting/processing unit 31 converts this control result into the communication format corresponding to the management apparatus based on the apparatus information that is stored in the management apparatus information DB 21 and corresponding to the management apparatus (Steps S202 and S203).

Subsequently, the result outputting/processing unit 31 converts the apparatus IP into the external public IP based on the address information that is acquired from the address information DB 23 by the address-information managing unit 36 and corresponding to the control target apparatus to be controlled (Step S204), and returns the control result to the management apparatus (Step S205).

Sequence of a Control-Execution/Result-Return Process

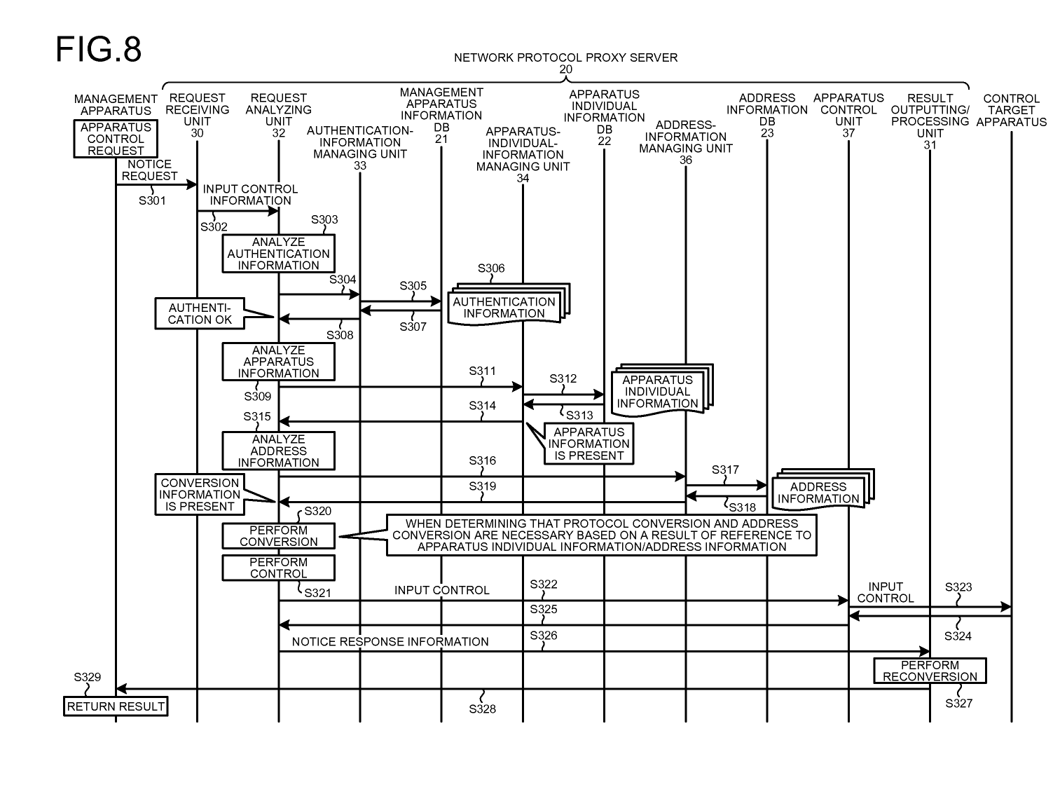

Next, a control-execution/result-return process performed by the network protocol proxy server is described with reference to FIG. 8. FIG. 8 is a sequence diagram illustrating a flow of the control-execution/result-return process in the network protocol proxy server according to the first embodiment.

As illustrated in FIG. 8, when a control request to a control target apparatus (network equipment) is input from a management apparatus, a “control request notice” message is transmitted to the network protocol proxy server 20 as an extended process of an “apparatus control request” process (Step S301).

When receiving the message, the request receiving unit 30 of the network protocol proxy server 20 issues a “control information input” event to the request analyzing unit 32 (Step S302). Subsequently, the request analyzing unit 32 acquires “identification information” and “authentication information” (e.g., an ID, a password, and a community name) of the management apparatus from the “control request notice” in order to perform an authentication process for the management apparatus in an “authentication information analysis” process, and outputs the acquired “identification information” and “authentication information” to the authentication-information managing unit 33 (Steps S303 and S304).

Then, the authentication-information managing unit 33 performs the authentication process by referring to an “authentication information” table being the authentication information stored in the management apparatus information DB 21 (performs authentication by referring to the “user ID” and the “password”). When determining that the authentication is successful, the authentication-information managing unit 33 outputs an “authentication OK” event to the request analyzing unit 32, and also outputs, as a communication protocol type between the management apparatus and the network protocol proxy server 20, data in a “data format” row on a column matching the “identification information” in the management apparatus information DB 21 to the request analyzing unit 32 (Steps S305 to S308).

The request analyzing unit 32 stores the received communication protocol type between the management apparatus and the network protocol proxy server 20, starts an “apparatus information analysis” process, and outputs an “information reference” event to the apparatus-individual-information managing unit 34 in order to refer to a protocol type of the control target equipment for which the control request has been issued (Steps S309 and S311).

Subsequently, the apparatus-individual-information managing unit 34 searches through an “apparatus individual information” table stored in the apparatus individual information DB 22 for information of the control target apparatus for which the reference request has been issued, acquires data present in the “protocol type” in the row hit by the search as a communication protocol type between the network protocol proxy server 20 and the equipment for which the control request has been issued, acquires data present in the “apparatus control information” in the same row as specifications of the protocol type, and outputs the acquired data to the request analyzing unit 32 (Steps S312 to S314).

Then, the request analyzing unit 32 stores the data received from the apparatus-individual-information managing unit 34, starts an “address information analysis” process (Step S315), and outputs to the address-information managing unit 36 the external IP address, for which the “apparatus control request” has been received from the management apparatus, as the address information (Step S316).

When receiving the address information, the address-information managing unit 36 searches through an “external public IP” column in an “address information” table stored in the address information DB 23 by using the external IP address as a search key, acquires data present in an “apparatus IP” row on the hit column as the address information assigned to the control target apparatus for which the control request has been issued, and outputs the address information to the request analyzing unit 32 (Steps S317 to S319).

When receiving the address information (apparatus IP) assigned to the control target apparatus, the request analyzing unit 32 determines that “conversion information is present”, and performs “execution of conversion” to set a destination address for transmitting telegram messages to the control target apparatus in subsequent processes (Step S320).

Then, the request analyzing unit 32 outputs to the apparatus control unit 37 a notice of execution of the control contents whose protocol has been converted for the control target apparatus, based on the control contents in the “control request notice” received from the management apparatus (Steps S321 and S322). The apparatus control unit 37 executes the converted control contents on the control target apparatus having the apparatus IP (Step S323).

Subsequently, the apparatus control unit 37 that has received a control execution result from the control target apparatus outputs the control result to the request analyzing unit 32 (Steps S324 and S325), and the request analyzing unit 32 outputs the received control result as a response to the result outputting/processing unit 31 (Step S326).

The result outputting/processing unit 31 that has received the execution result refers to the management apparatus information DB 21 to acquire the “communication format” and the “data format” of the management apparatus to which a response result is to be output, reconverts the received execution result into the acquired “communication format” and the “data format” of the management apparatus (Step S327), and transmits the reconverted execution result as a response of the result to the management apparatus (Steps S328 and S329).

Advantage of First Embodiment

As described above, according to the first embodiment, the management apparatus information DB 21 stores therein identification information for uniquely identifying each of the management apparatuses and a communication format of each of the management apparatuses; the apparatus individual information DB 22 stores therein apparatus information for executing various types of control, in association with each apparatus to be a control target apparatus; whether authentication information contained in a control request is stored in the management apparatus information DB 21 is determined upon receiving the control request from the plurality of management apparatuses; apparatus information corresponding to a control target apparatus to be controlled by the received control request is acquired from the apparatus individual information DB 22 upon determining that the authentication information is stored in the management apparatus information DB 21; control information contained in the control request and indicating control contents is converted based on the acquired apparatus information; and the converted control information is executed on the control target apparatus. Therefore, it is possible to authenticate the validity of the management apparatus and perform advanced control independent of the communication format of the management apparatus.

Furthermore, according to the first embodiment, the network protocol proxy server 20 can perform authentication by proxy such that it performs authentication of all managing control target equipments in advance so that the management apparatus can control the control target equipments managed by the network protocol proxy server 20 only by performing authentication with the network protocol proxy server 20 once.

Moreover, according to the first embodiment, when an execution result indicating a result of execution of the converted control information on the control target apparatus is received from the control target apparatus, the communication format corresponding to the management apparatus being a transmission destination of the control request is acquired from the management apparatus information DB 21; the control result is converted based on the acquired communication format; and the management apparatus is notified of the converted control result. Therefore, it is possible to accurately notify the management apparatus of the control execution result.

Furthermore, according to the first embodiment, the address information DB 23 stores therein address information containing an external IP address and an internal IP address associated with each other, in association with each apparatus to be a control target apparatus; control information contained in the control request and indicating the control contents is converted based on the acquired apparatus information; an internal IP address associated with the external IP address that is contained in the control request and assigned to the control target apparatus is acquired from the address information DB 23; and the converted control information is executed on the control target apparatus by using the acquired internal IP address. Therefore, unlike a case in which a management apparatus (NMS) directly accesses a management target equipment (control target apparatus), it is possible to conceal a configuration (IP address assignment system and the like) of a network accommodating the management target equipments from the NMS and prevent the equipments from being directly operated by external apparatuses. Furthermore, it is possible to cause an authorized NMS to control the equipments only via a proxy server.

### [b] Second Embodiment

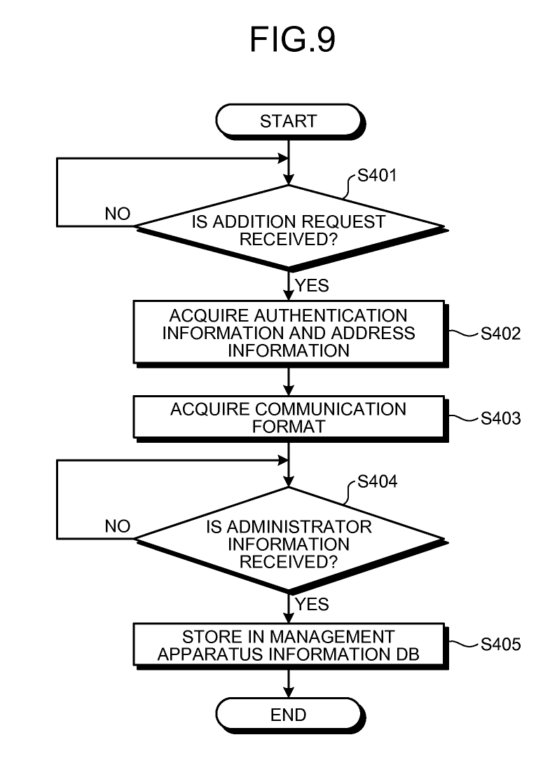

The present invention is able to authenticate a new management apparatus that performs various types of control and automatically register the new management apparatus in the management apparatus information DB 21. In the second embodiment, a case in which a new management apparatus is additionally registered is explained with reference to FIG. 9. FIG. 9 is a flowchart illustrating a flow of an additional registration process for additionally registering a new management apparatus according to the second embodiment.

As illustrated in FIG. 9, when the request receiving unit 30 receives an addition request from a new management apparatus (YES at Step S401), the request analyzing unit 32 of the network protocol proxy server 20 acquires “authentication information (e.g., an ID, a password, and a community name)” for authenticating the new management apparatus and “address information (e.g., an IP address)” of the new management apparatus from the addition request (Step S402).

Subsequently, the request analyzing unit 32 of the network protocol proxy server 20 acquires a “communication format (e.g., NETCONF, SNMP, and HTTP)” for performing communication with the new management apparatus from the addition request (Step S403).

Then, the request analyzing unit 32 of the network protocol proxy server 20 receives information such as an “administrator name” and an “authorization group” from an administrator of the new management apparatus (YES at Step S404), and stores the received information and the acquired “authentication information” and “address information” in the management apparatus information DB 21 in association with newly-created “identification information” (Step S405). After the information is stored in the management apparatus information DB 21 in this manner, the management apparatus is authenticated and then various types of control are performed in the same manner as the first embodiment. When deleting a management apparatus, the request analyzing unit 32 of the network protocol proxy server 20 receives a deletion request and deletes the management apparatus that has sent the deletion request from the management apparatus information DB 21.

Advantage of Second Embodiment

As described above, according to the second embodiment, when a new management apparatus that is not stored in the management apparatus information DB 21 is to be added, authentication information is received from the new management apparatus, a communication format at the time of reception of the authentication information is acquired, and the received authentication information and the acquired communication format are newly stored in the management apparatus information DB 21 in association with each other. Therefore, it is possible to flexibly add and delete new management apparatuses, resulting in improved convenience.

### [c] Third Embodiment

In the second embodiment, it is explained that a new management apparatus that performs various types of control is automatically registered in the management apparatus information DB 21. However, the present invention is not limited to this embodiment. It is possible to automatically register a new control target apparatus in the apparatus individual information DB 22.

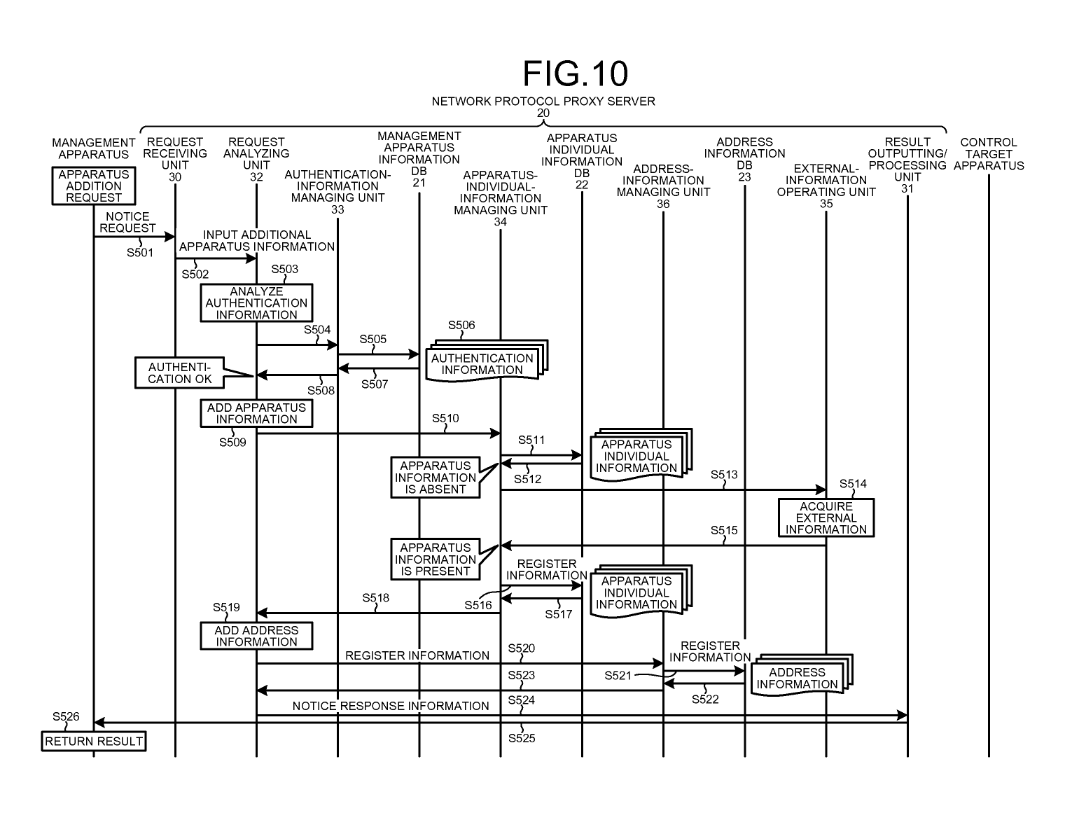

In the third embodiment, a case in which a new control target apparatus is additionally registered is explained with reference to FIG. 10. FIG. 10 is a sequence diagram illustrating a flow of an additional registration process for additionally registering a new control target apparatus according to the third embodiment.

As illustrated in FIG. 10, before controlling a new control target apparatus, a management apparatus transmits an “apparatus addition request” message to the network protocol proxy server 20 to register the new control target apparatus in the network protocol proxy server 20 of the present invention (Step S501).

Subsequently, when receiving the message, the request receiving unit 30 of the network protocol proxy server 20 issues an “additional apparatus information input” event to the request analyzing unit 32 (Step S502).

Then, the request analyzing unit 32 issues an “information reference” event to the authentication-information managing unit 33 to perform an authentication process on the management apparatus that has transmitted the “apparatus addition request” in an “authentication information analysis” process (Steps S503 and S504). The authentication-information managing unit 33 performs the authentication process by referring to an “authentication information” table stored in the management apparatus information DB 21, and, when the “authentication information” is stored in the management apparatus information DB 21, the authentication-information managing unit 33 outputs an “authentication OK” event to the request analyzing unit 32 (Steps S505 to S508).

Accordingly, the request analyzing unit 32 starts an “apparatus information addition” process, and issues an “information reference” event to cause the apparatus-individual-information managing unit 34 to register the new control target apparatus for which a registration request has been issued (Steps S509 and S510).

Then, the apparatus-individual-information managing unit 34 refers to an “apparatus individual information” table stored in the apparatus individual information DB 22 to search for information about the new control target apparatus for which the registration request has been issued (Steps S511 and S512).

When the apparatus information is not present, the apparatus-individual-information managing unit 34 issues an event to the external-information operating unit 35 to acquire information such as specifications related to the new control target apparatus for which the registration request has been issued (Step S513).

Then, the external-information operating unit 35 acquires the information such as specifications related to the new control target apparatus from an external network such as the Internet (e.g., from home pages of various vendors), and outputs the information to the apparatus-individual-information managing unit 34 (Steps S514 and S515).

The apparatus-individual-information managing unit 34 adds the information such as specifications related to the network equipment in the “apparatus individual information” table stored in the apparatus individual information DB 22 (Steps S516 and S517). In other words, by additionally registering a record in the “apparatus individual information” table, the network equipment for which the registration request has been issued is managed by a proxy server.

Subsequently, the apparatus-individual-information managing unit 34 issues an event to the request analyzing unit 32 (Step S518). When receiving the event, the request analyzing unit 32 starts an “address information addition” process, and outputs to the address-information managing unit 36 address information that is received by using the “apparatus addition request” message from the management apparatus and corresponding to the new control target apparatus (Steps S519 and S520).

Then, when receiving the address information, the address-information managing unit 36 registers the address information in an “address information” table in the address information DB 23, and, when completing the registration, the address-information managing unit 36 issues an event to the request analyzing unit 32 (Steps S521 to S523).

When receiving the event, the request analyzing unit 32 issues an “response information notice” event to the result outputting/processing unit 31 (Step S524). The result outputting/processing unit 31 then transmits a result of the registration of the new control target apparatus to the management apparatus (Step S525). When receiving the result, the management apparatus performs a “result response” process, and notifies a person performing maintenance of the result of the registration of the new control target apparatus in this process (Step S526). When a control target apparatus is to be deleted, it can easily be deleted in the same manner.

Advantage of Third Embodiment

As described above, according to the third embodiment, a new control target apparatus can easily be registered in the network protocol proxy server 20 of the present invention before starting control of the new control target apparatus. Therefore, it is possible to reduce loads on repair and maintenance operations related to addition and deletion of control target apparatuses, resulting in improved convenience.

### [d] Fourth Embodiment

In the third embodiment, it is explained that a new control target apparatus is automatically registered in the apparatus individual information DB 22. However, the present invention is not limited to this embodiment. When information on a control target apparatus is updated by version up, software updating, and the like, it is possible to automatically reflect the update information in the apparatus individual information DB 22.

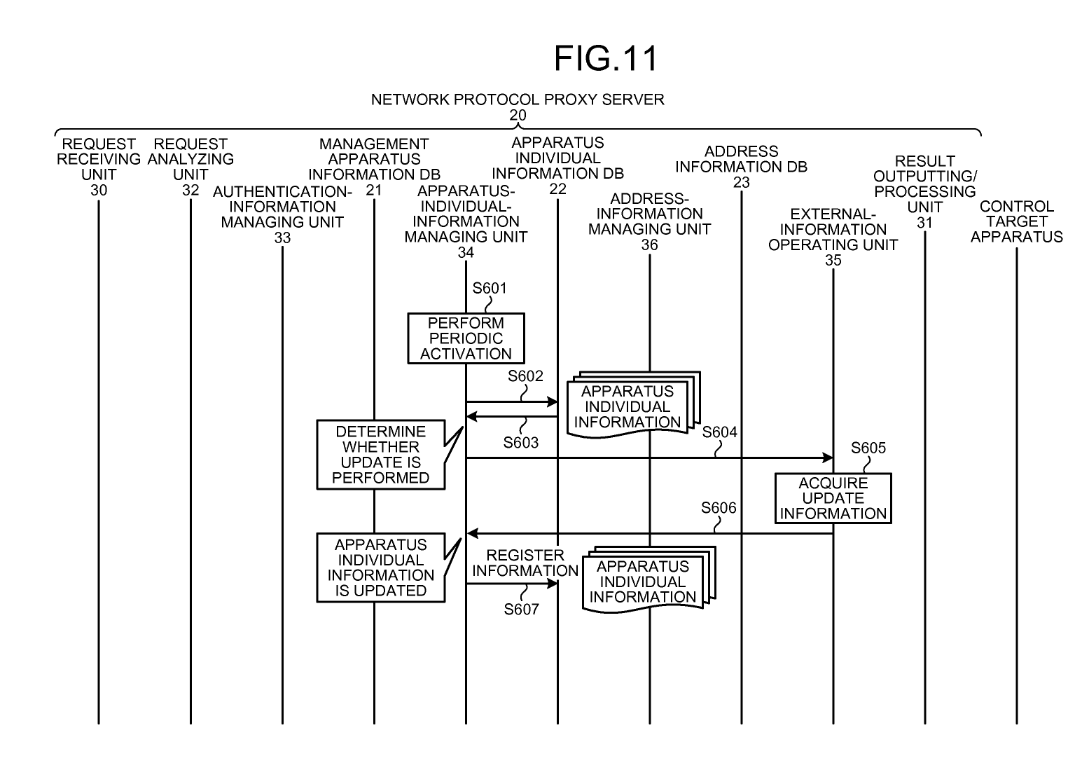

In the fourth embodiment, a case in which update information is automatically reflected in the apparatus individual information DB 22 when information on a control target apparatus is updated by version up, software updating, and the like is explained with reference to FIG. 11. FIG. 11 is a sequence diagram illustrating a flow of an apparatus-individual-information DB update process according to the fourth embodiment.

As illustrated in FIG. 11, the apparatus-individual-information managing unit 34 of the network protocol proxy server 20 determines whether there is an apparatus being in the period of update by referring to the “update information” stored in the apparatus individual information DB 22 (Steps S601 to S603).

When there is the apparatus being in the period of update, the apparatus-individual-information managing unit 34 acquires address information and the like corresponding to an update-information acquisition source written in the “update information” stored in the apparatus individual information DB 22, and outputs to the external-information operating unit 35 the acquired address information of the update-information acquisition source and an instruction to acquire new information of a control target apparatus falling in the period of update (Step S604).

The external-information operating unit 35 that has received the instruction accesses the address information of the update-information acquisition source to acquire the update information, and outputs the acquired update information to the apparatus-individual-information managing unit 34 (Steps S605 and S606).

Then, the apparatus-individual-information managing unit 34 stores the update information received from the external-information operating unit 35 in each table of a corresponding control target apparatus stored in the apparatus individual information DB 22 to thereby update the apparatus information of the control target apparatus (Step S607).

Advantage of Fourth Embodiment

As described above, according to the fourth embodiment, update information of each apparatus information of a control target apparatus is periodically acquired from an external network, and the apparatus information stored in the apparatus individual information DB 22 is updated with the acquired update information. Therefore, it is possible to store the latest apparatus information at any time. As a result, it is possible to select the latest protocol suitable for the communication format of a control target apparatus for performing control.

### [e] Fifth Embodiment

Although the embodiments of the present invention have been described above, the present invention can be embodied in various different forms other than the embodiments described above. Another embodiment of the present invention will be explained in divided sections as follows: (1) autonomous control on a control target apparatus; (2) autonomous collection of information from a control target apparatus and execution of a process of processing the collected information; (3) system configuration and the like; and (4) computer programs.

(1) Autonomous Control on a Control Target Apparatus

For instance, the network protocol proxy server 20 of the present invention can autonomously control a control target apparatus. In the fifth embodiment, a case in which the network protocol proxy server 20 autonomously performs control on a control target apparatus is described.

More specifically, when a management apparatus is to perform control on a control target apparatus periodically or at a predetermined moment (a moment at which status of the equipment changes and the like), a control policy is set in the network protocol proxy server 20 so that the network protocol proxy server 20 can autonomously perform the control in place of the management apparatus.

For example, when a management apparatus issues a request of autonomous control to the request receiving unit 30 of the network protocol proxy server 20, the request receiving unit 30 notifies the request analyzing unit 32 of the request. Then, the request analyzing unit 32 analyzes a condition of the received autonomous control, and notifies the apparatus-individual-information managing unit 34 of an execution condition for each target apparatus. Then, the apparatus-individual-information managing unit 34 stores the notified condition for the autonomous control in the apparatus individual information DB 22.

Subsequently, the request analyzing unit 32 requests the apparatus-individual-information managing unit 34 to periodically refer to the apparatus individual information DB 22 to determine presence and absence of the autonomous control condition. Then, when the autonomous control conditions is present, the request analyzing unit 32 requests the apparatus control unit 37 to perform control input to a control target apparatus to be controlled, according to the set condition stored in control condition information. For example, when the control condition information is set to acquire information from a control target apparatus every five minutes, the request analyzing unit 32 inputs control information for acquiring information every five minutes to the apparatus control unit 37.

It is possible to further perform control depending on a result of the control input and a notice of information from the control target apparatus. For example, when the control condition for acquiring information from a control target apparatus every five minutes and control information for an acquired value of “0” are set, the request analyzing unit 32 inputs control information for acquiring information every five minutes to the apparatus control unit 37, receives a result, and evaluates an acquired value. Then, when the acquired value is “0”, the request analyzing unit 32 inputs the set control information to the apparatus control unit 37, and, when the acquired value is not “0”, the request analyzing unit 32 ends the process.

As described above, the network protocol proxy server 20 can autonomously control a control target apparatus. As a result, even a control that needs to be performed periodically can easily be executed. Furthermore, it is possible to prevent control from being remained unexecuted that may occur during manual operations.

(2) Autonomous Collection of Information from a Control Target Apparatus and Execution of a Process of Processing the Collected Information

For instance, the network protocol proxy server 20 of the present invention can autonomously collect information from a control target apparatus and execute a processing process on the collected information. In the fifth embodiment, a case is explained in which the network protocol proxy server 20 autonomously collects information from a control target apparatus and performs a process of processing the collected information.

More specifically, when a management apparatus collects information stored in a control target apparatus (e.g., information about various states of the equipment), the network protocol proxy server 20 can collect the information in place of the management apparatus. In this case, the network protocol proxy server 20 performs a collection process and a processing process (e.g., calculation for statistics) as described below on the collected information in relaying information in place of the management apparatus. Consequently, it is possible to generate information not stored in the control target apparatus by the processing.

More specifically, the network protocol proxy server 20 autonomously performs processes such as “1. a process of periodically collecting information (e.g., collection of a CPU usage rate or a buffer usage rate per one second in a management target equipment) and notifying a management apparatus of a summary of a collection result if necessary”; “2, a process of processing the collected information (e.g., when the management target apparatus is a router, a process of calculating a packet loss rate based on the total number of transferred packets and the total number of transfer failed packets)”; and “3. a process of giving a notice to the management apparatus when the collected information exceeds a certain threshold”.

Furthermore, the network protocol proxy server 20 can process information over a plurality of control target apparatuses when performing the processing process on the collected information. For example, the network protocol proxy server 20 registers control to acquire information per one second, for example, as autonomous control on the control target apparatuses according to the same procedure as the fifth embodiment. Then, the request analyzing unit 32 gives a notice of an acquired value received from the apparatus control unit 37 and a notice that a process is to be performed, to the result outputting/processing unit 31. The result outputting/processing unit 31 accumulates notified values, calculates a processed value according to a specified process condition when accumulated values necessary for the process are obtained, and notifies the management apparatus of the processed value.

In this manner, it is possible to periodically monitor performance of an apparatus and process periodically-collected information. Therefore, it is possible to recognize performance and loads on the apparatus, which can be used for maintenance of the control target apparatus.

(3) System Configuration and the Like

The constituent elements of the apparatuses illustrated in the drawings are based on functional concepts and do not necessarily have to be physically arranged in the way illustrated in the drawings. In other words, the specific mode in which the constituent elements are disintegrated and integrated is not limited to the ones illustrated in the drawings. A part or all of the apparatuses can be disintegrated or integrated, either functionally or physically in any arbitrary units according to various loads and use conditions (e.g., the request receiving unit and the result outputting/processing unit may be integrated). A part or all of the processing functions offered by the constituent elements can be realized by a CPU and a computer program analyzed and executed by the CPU, or may be realized as hardware with wired logic.

Of the various processes explained in the embodiments, it is acceptable to manually perform a part or whole of the processing that is explained to be performed automatically (e.g., a process for acquiring authentication information, identification information, and address information from a control request). Conversely, it is acceptable to automatically perform, using known techniques, a part or whole of the processing that is explained to be performed manually (e.g., a process for receiving an authorization group when adding a management apparatus). In addition, the processing procedures, the control procedures, the specific names, and the information including various types of data and parameters that are presented in the text and the drawings can be modified in any form, except when it is noted otherwise.

(4) Computer Programs

Various processes described in the above embodiments can be performed by executing prepared computer programs using a computer system such as a personal computer and a workstation. An explanation will be given below of, as another embodiment, a computer system that executes a computer program that has the same functions as those described in the above embodiments.

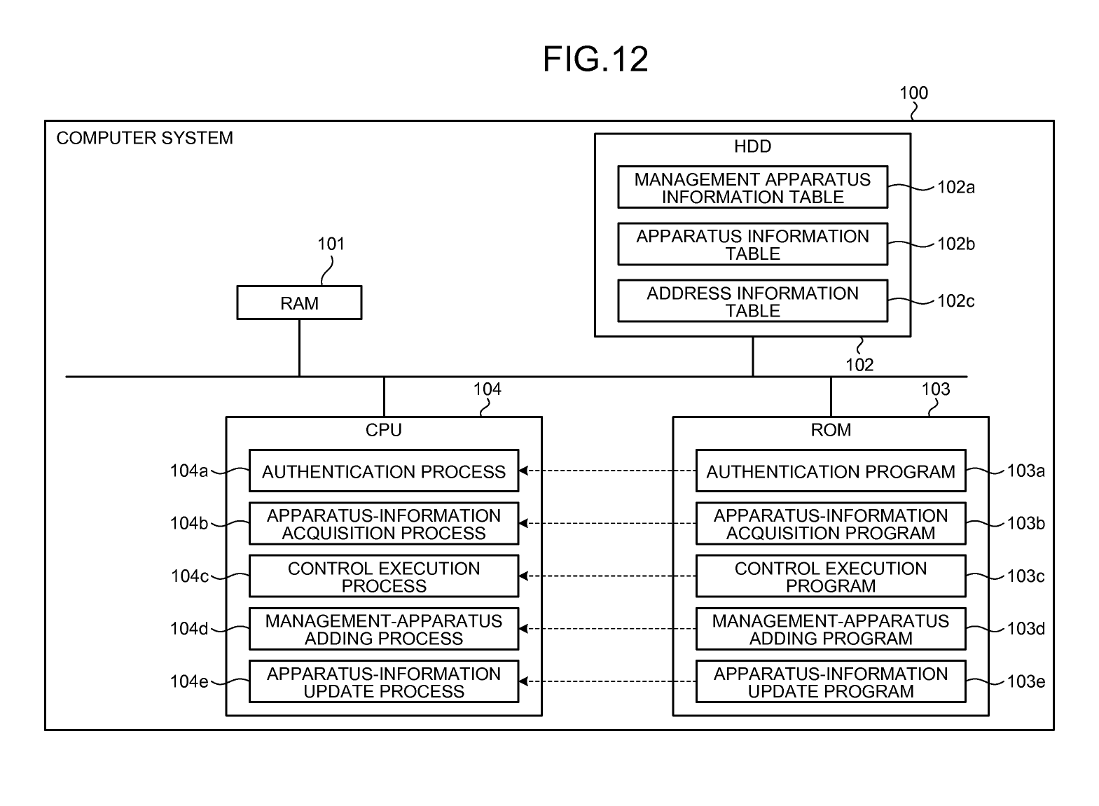

FIG. 12 is a diagram illustrating an exemplary computer that executes a control proxy program. As illustrated in FIG. 12, a computer system 100 includes a Random Access Memory (RAM) 101, a Hard Disk Drive (HDD) 102, a Read Only Memory (ROM) 103, and a Central Processing Unit (CPU) 104. The ROM 103 preliminarily stores therein computer programs that implement the same functions as those of the above embodiments, i.e., as illustrated in FIG. 12, an authentication program 103a, an apparatus-information acquisition program 103b, a control execution program 103c, a management-apparatus adding program 103d, and an apparatus-information update program 103e.

The CPU 104 reads and executes the programs 103a to 103e to thereby implement an authentication process 104a, an apparatus-information acquisition process 104b, a control execution process 104c, a management-apparatus adding process 104d, and an apparatus-information update process 104e as illustrated in FIG. 12. The authentication process 104a corresponds to the request analyzing unit 32 and the authentication-information managing unit 33 illustrated in FIG. 2; the apparatus-information acquisition process 104b corresponds to the request analyzing unit 32 and the apparatus-individual-information managing unit 34; the control execution process 104c corresponds to the request analyzing unit 32 and the apparatus control unit 37; the management-apparatus adding process 104d corresponds to the request analyzing unit 32; and the apparatus-information update process 104e corresponds to the request analyzing unit 32 and the external-information operating unit 35.

The HDD 102 includes a management apparatus information table 102a for storing authentication information for uniquely identifying each of management apparatuses and communication formats of the respective management apparatuses, an apparatus information table 102b for storing apparatus information necessary for executing various types of control, in association with various apparatuses to be controlled, and an address information table 102c for storing address information containing an external IP address and an internal IP address associated with each other. The management apparatus information table 102a corresponds to the management apparatus information DB 21 illustrated in FIG. 2; the apparatus information table 102b corresponds to the apparatus individual information DB 22; and the address information table 102c corresponds to the address information DB 23.

The above programs 103a to 103e are not necessarily stored in the ROM 103. For example, they can be stored in a “portable physical medium” such as a flexible disk (FD), a CD-ROM, a magneto-optical disk, a DVD disk, an IC card, and the like insertable to the computer system 100; a “fixed physical medium” such as a hard disk drive (HDD) that can be arranged inside or outside the computer system 100; and “another computer system” connected to the computer system 100 via a public line, the Internet, a LAN, a WAN, and the like, and can be executed by the computer system 100 reading out the computer program from such media.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control proxy apparatus comprising:
a management-apparatus-information storage unit that stores therein identification information for uniquely identifying each of a plurality of management apparatuses that manage various apparatuses and a communication format of each of the management apparatuses;
an apparatus-information storage unit that stores therein apparatus information for executing various types of control, in association with each apparatus to be a control target apparatus;
an authenticating unit that determines, when receiving a control request for requesting execution of various types of control from the plurality of management apparatuses, whether authentication information stored in the control request is stored in the management-apparatus-information storage unit;
an apparatus-information acquiring unit that acquires, when the authenticating unit determines that the authentication information is stored in the management-apparatus-information storage unit, apparatus information corresponding to the control target apparatus to be controlled by the received control request, from the apparatus-information storage unit; and
a control executing unit that converts control information contained in the control request and indicating control contents based on the apparatus information acquired by the apparatus-information acquiring unit, and executes the converted control information on the control target apparatus.

2. The control proxy apparatus according to claim 1, further comprising:
a management-apparatus adding unit that receives, when a new management apparatus that is not stored in the management-apparatus-information storage unit is to be added, authentication information from the new management apparatus, acquires a communication format at the time of reception of the authentication information, and stores the received authentication information and the acquired communication format in association with each other in the management-apparatus-information storage unit.

3. The control proxy apparatus according to claim 1, wherein
the control executing unit acquires, when receiving a control execution result indicating a result of execution of the converted control information on the control target apparatus, a communication format corresponding to the management apparatus being a transmission destination of the control request from the management-apparatus-information storage unit, converts the control result based on the acquired communication format, and notifies the management apparatus of the control execution result.

4. The control proxy apparatus according to claim 1, further comprising:
an address-information storage unit that stores therein address information containing an external IP address and an internal IP address associated with each other, in association with each apparatus to be the control target apparatus, wherein
the control executing unit converts the control information contained in the control request and indicating control contents based on the apparatus information acquired by the apparatus-information acquiring unit, acquires an internal IP address associated with an external IP address contained in the control request and assigned to the control target apparatus, from the address-information storage unit, and executes the converted control information on the control target apparatus by using the acquired internal IP address.

5. The control proxy apparatus according to claim 1, further comprising:
an apparatus-information updating unit that periodically acquires update information of each apparatus information of the control target apparatus from an external network, and updates the apparatus information stored in the apparatus-information storage unit with the acquired update information.

6. A control proxy method comprising:
firstly storing identification information for uniquely identifying each of a plurality of management apparatuses that manage various apparatuses and a communication format of each of the management apparatuses;
secondly storing apparatus information for executing various types of control, in association with each apparatus to be a control target apparatus;
determining, when receiving a control request for requesting execution of various types of control from the plurality of management apparatuses, whether authentication information stored in the control request is stored in the firstly storing;
acquiring, when it is determined in the determining that the authentication information is stored in the firstly storing, apparatus information corresponding to the control target apparatus to be controlled by the received control request, from information stored in the secondly storing; and
converting control information contained in the control request and indicating control contents based on the apparatus information acquired in the acquiring, and executing the converted control information on the control target apparatus.

7. A computer readable storage medium having stored therein a control proxy program, the program causing a computer to execute a process comprising:
firstly storing identification information for uniquely identifying each of a plurality of management apparatuses that manage various apparatuses and a communication format of each of the management apparatuses;
secondly storing apparatus information for executing various types of control, in association with each apparatus to be a control target apparatus;
determining, when receiving a control request for requesting execution of various types of control from the plurality of management apparatuses, whether authentication information stored in the control request is stored in the firstly storing;
acquiring, when it is determined in the determining that the authentication information is stored in the firstly storing, apparatus information corresponding to the control target apparatus to be controlled by the received control request, from information stored in the secondly storing; and
converting control information contained in the control request and indicating control contents based on the apparatus information acquired in the acquiring, and executing the converted control information on the control target apparatus.
